(19) United States
(12) Patent Application Publication
(10) Pub. No.: US 2025/0203630 A1
(43) Pub. Date: Jun. 19, 2025

(54) Enabling a Single DCI to Schedule Multiple Cells

(71) Applicant: Apple Inc., CUPERTINO, CA (US)

(72) Inventors: Haitong SUN, Saratoga, CA (US); Chunxuan YE, San Diego, CA (US); Dawei ZHANG, Saratoga, CA (US); Hong HE, San Jose, CA (US); Jie CUI, San Jose, CA (US); Wei ZENG, Saratoga, CA (US); Yushu ZHANG, Beijing (CN)

(21) Appl. No.: 18/849,684

(22) PCT Filed: Mar. 31, 2022
(86) PCT No.: PCT/CN2022/084367

§ 371 Date: Sep. 23, 2024

(51) Int. Cl. H04W 72/232; H04W 48/12; H04W 72/0446

(52) U.S. Cl. CPC H04W 72/232; H04W 48/12; H04W 72/0446

(57) ABSTRACT

A user equipment (UE) is configured to receive, from a network, scheduling configuration information related to scheduling a physical downlink shared channel (PDSCH) or a physical uplink shared channel (PUSCH) for the UE, receive, from a scheduling cell of the network, downlink control information (DCI) comprising scheduling information for the PDSCH or PUSCH for a plurality of scheduled cells, decode the DCI and determine a schedule for each of the scheduled cells based on at least the scheduling configuration information and the scheduling information.

### TECHNICAL FIELD

The present disclosure relates to wireless communication, and in particular, to enabling a single DCI to schedule multiple cells.

### BACKGROUND

In a new radio (NR) network, a single downlink control information (DCI) can only be used to schedule physical downlink shared channel (PDSCH) or physical uplink shared channel (PUSCH) on one cell. Additionally, in the NR network, there are cross carrier scheduling (CCS) restrictions including, but not limited to, a primary cell having the ability to only perform self-scheduling, a cross-carrier scheduled cell being unable to schedule another cell, unsupported cell grouping, etc. As a result, the NR network may benefit from improving scheduling flexibility to accommodate multi-cell scheduling using a single DCI. Accordingly, there is a need for scheduling configuration enhancements that allows a single DCI to schedule PDSCH or PUSCH in multiple cells.

### SUMMARY

Some exemplary embodiments are related to a processor of a user equipment (UE) configured to receive, from a network, scheduling configuration information related to scheduling a physical downlink shared channel (PDSCH) or a physical uplink shared channel (PUSCH) for the UE, receive, from a scheduling cell of the network, downlink control information (DCI) comprising scheduling information for the PDSCH or PUSCH for a plurality of scheduled cells, decode the DCI and determine a schedule for each of the scheduled cells based on at least the scheduling configuration information and the scheduling information.

Other exemplary embodiments are related to a user equipment (UE) having a transceiver configured to communicate with a network and a processor communicatively coupled to the transceiver and configured to receive, from the network, scheduling configuration information related to scheduling a physical downlink shared channel (PDSCH) or a physical uplink shared channel (PUSCH) for the UE, receive, from a scheduling cell of the network, downlink control information (DCI) comprising scheduling information for the PDSCH or PUSCH for a plurality of scheduled cells, decode the DCI and determine a schedule for each of the scheduled cells based on at least the scheduling configuration information and the scheduling information.

Still further exemplary embodiments are related to a processor of a base station configured to send, to a user equipment (UE), scheduling configuration information related to scheduling a physical downlink shared channel (PDSCH) or a physical uplink shared channel (PUSCH) for the UE and send, to the UE, downlink control information (DCI) comprising scheduling information for the PDSCH or PUSCH for a plurality of scheduled cells.

Additional exemplary embodiments are related to a base station having a transceiver configured to communicate with a user equipment (UE) and a processor communicatively coupled to the transceiver and configured to send, to a user equipment (UE), scheduling configuration information related to scheduling a physical downlink shared channel (PDSCH) or a physical uplink shared channel (PUSCH) for the UE and send, to the UE, downlink control information (DCI) comprising scheduling information for the PDSCH or PUSCH for a plurality of scheduled cells.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows an general overview of a multi-cell arrangement where multiple cells may be scheduled for the UE according to various exemplary embodiments.

FIG. 5 shows a first example multi-cell scheduling configuration according to various exemplary embodiments.

FIG. 6 shows a second example of multi-cell scheduling configuration according to various exemplary embodiments.

FIG. 7 shows a third example multi-cell scheduling configuration according to various exemplary embodiments.

FIG. 8 shows a fourth example of multi-cell scheduling configuration according to various exemplary embodiments.

FIG. 9 shows a fifth example of multi-cell scheduling configuration according to various exemplary embodiments.

FIG. 10 shows a first example multi-cell search space scheduling configuration according to various exemplary embodiments.

FIG. 11 shows a second example multi-cell search space scheduling configuration according to various exemplary embodiments.

FIG. 12 shows a third example multi-cell search space scheduling configuration according to various exemplary embodiments.

FIG. 13 shows a fourth example multi-cell search space scheduling configuration according to various exemplary embodiments.

### DETAILED DESCRIPTION

The exemplary embodiments may be further understood with reference to the following description and the related appended drawings, wherein like elements are provided with the same reference numerals. The exemplary embodiments relate to a base station (e.g., gNB) generating scheduling configurations for a user equipment (UE) to configure multi-cell scheduling via a single downlink control information (DCI) using cross carrier scheduling (CCS). The multi-cell scheduling may be for a Physical Downlink Shared Channel (PDSCH) or Physical Uplink Shared Channel (PUSCH). As will be described in more detail below, implementing this type of configuration provides a UE with more scheduling flexibility with regard to scheduling and thus, may improve network performance.

The exemplary embodiments are described with regard to a UE. However, reference to the term UE is merely provided for illustrative purposes. The exemplary embodiments may be utilized with any electronic component that is configured with the hardware, software, and/or firmware to exchange information (e.g., control information) and/or data with the network. Therefore, the UE as described herein is used to represent any suitable electronic device.

Throughout this description, specific names of parameters or information elements (IEs) may be used. For example, a configuration IE that is transmitted by the network to the UE for CCS may be described as a CrossCarrierSchedulingConfig IE. It should be understood that the specific names of parameters or IEs are only exemplary and the configuration information that is provided by the parameters and/or IEs may be provided to the UE in different manners, including by parameters and/or IEs having different names.

The exemplary embodiments are described with regard to CCS in 5G NR. Those skilled in the art will understand that CCS generally refers to a configuration where a scheduling cell is configured to transmit DCI to the UE for PDSCH reception or PUSCH transmission in a cell other than the scheduling cell. However, there are some CCS restrictions in 5G NR with regards to the UE accommodating the complexity of the CCS. For instance, under conventional circumstances, for CCS in 5G NR, a primary cell (e.g., P(S) Cell or SpCell) of a master cell group (MCG) or secondary cell group (SCG) can only be self-scheduled. In another instance, although a scheduling cell can schedule up to 8 scheduled cells, a scheduled cell can only have one scheduling cell. In another instance, a cell configured to be scheduled by a different scheduling cell cannot be configured to schedule a subsequent cell configured to be scheduled by a scheduling cell. Additionally, CCS in 5G NR does not support cross cell group (CG) or PUCCH-group scheduling. Although some enhancements were introduced to provide more scheduling flexibility for the primary cell, the enhancements focused on allowing the primary cell to be scheduled by itself and an additional scheduling cell. That is, the enhancements provided the network with more scheduling flexibility when a primary cell coexists with LTE CRS.

Additionally, under the current 5G NR standards, a single DCI can only be used to schedule PDSCH or PUSCH on one cell at a given time. The network indicates the scheduled cell or the cell carrying PDSCH or PUSCH to the UE by a carrier indicator field (CIF) in the DCI. Thus, during the CCS, the network implements a configuration to map the carrier indicator to the actual cell via a CrossCarrierSchedulingConfig information element (IE) through Radio Resource Control (RRC) signaling. The RRC signaling informs the UE of the state of the carrier indicator. For instance, the RRC may report the carrier indicator=0, indicating that the cell received is self-scheduling and thus, the UE should transmit PUSCH or receive PDCSH on the current scheduling cell. In another instance, when the carrier indicator=1, the network may configure the UE to transmit PUSCH or receive PDCSH on another cell.

Despite the enhancements, a single DCI is not configured by the base station to schedule multiple cells simultaneously. Conventionally, for the base station to schedule multiple cells, the base station has to send multiple DCIs to the UE to schedule the multiple cells for, e.g., PDSCH, PUSCH, etc. This configuration may not be an effective use of the network because it lacks scheduling flexibility causing performance degradation on the UE side and/or the network side for 5G NR operations.

Thus, the exemplary embodiments relate to the base station sending a configuration to the UE to allow a single DCI to schedule multiple cells. The UE may be configured to implement a multi-cell PSDCH or PUSCH scheduling via a single DCI using some design considerations such as CrossCarrierSchedulingConfig design, search space configuration restrictions, determining the number of unicast DCI to decode and implementing configuration restriction on the multi-cell scheduling. By implementing the above design considerations, the base station may reduce the control overhead on the DCI to allow a more controlled scheduling flexibility which potentially saves some resources for data in other configurations for the UE. Each of these exemplary configurations are described in greater detail below.

Although the exemplary embodiments are described with regard to allowing a single DCI to schedule multiple cells, the exemplary embodiments are not limited to the above and may apply to any appropriate scenario in which a single signaling may schedule multiple cells. The exemplary techniques described herein may be used in conjunction with currently implemented CCS configurations, future implementations of CCS configurations or with any other appropriate mechanisms related to a single DCI configured to schedule multiple cells.

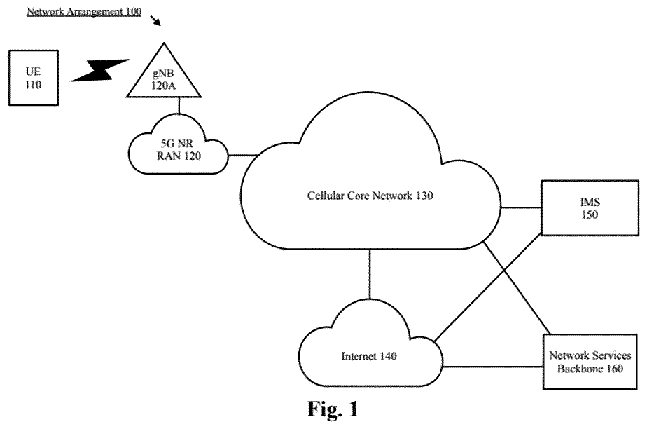

FIG. 1 shows an exemplary network arrangement 100 according to various exemplary embodiments. The exemplary network arrangement 100 includes the UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network arrangement 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a WLAN, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR-RAN 120 may be a portion of cellular networks that may be deployed by cellular providers (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

The UE 110 may connect to the 5G NR-RAN 120 via the gNB 120A. Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific base station (e.g., gNB 120A). However, as mentioned above, reference to the 5G NR-RAN 120 is merely for illustrative purposes and any appropriate type of RAN may be used.

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. It may include the EPC and/or the 5GC. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

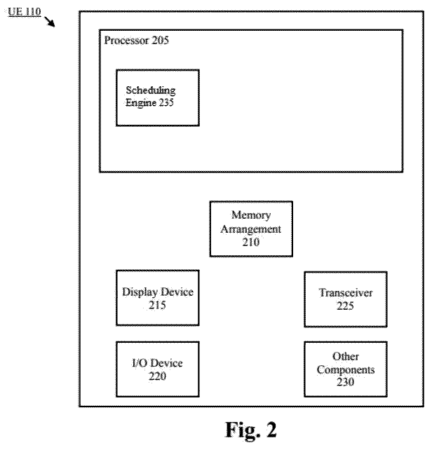

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a scheduling engine 235. The scheduling engine 235 may perform various operations related to the scheduling of multiple cells using a single DCI as described herein. These operations may include, but are not limited to, scheduling the multiple cells via the single DCI using design considerations configured by the gNB such as CrossCarrierSchedulingConfig design, search space configuration restrictions, determining the number of unicast DCI the UE is expected to decode and implementing a configuration restriction, managing network configurations and transmitting design configurations for multi-cell PDSCH/PUSCH scheduling via a single DCI. Each of these various operations will be described in greater detail below.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies).

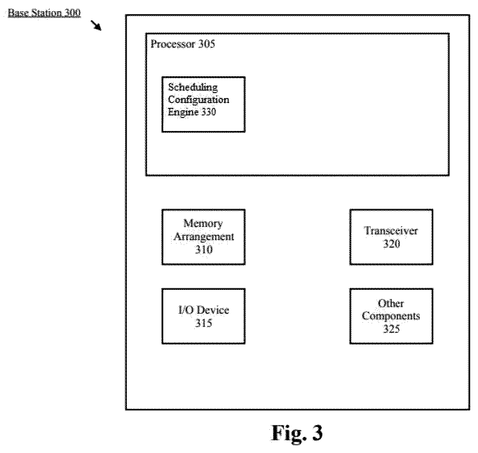

FIG. 3 shows an exemplary base station 300 according to various exemplary embodiments. The base station 300 may represent any access node (e.g., gNB 120A, etc.) through which the UE 110 may establish a connection and manage network operations.

The base station 300 may include a processor 305, a memory arrangement 310, an input/output (I/O) device 315, a transceiver 320, and other components 325. The other components 325 may include, for example, a battery, a data acquisition device, ports to electrically connect the base station 300 to other electronic devices, etc.

The processor 305 may be configured to execute a plurality of engines of the base station 300. For example, the engines may include a scheduling configuration engine 330. The scheduling configuration engine 330 may perform various operations related to the exemplary CCS enhancements for single DCI described herein. The operations may include, but are not limited to, transmitting scheduling configuration design information to the UE. Each of these various operations will be described in greater detail below.

The above noted engine 330 being an application (e.g., a program) executed by the processor 305 is only exemplary. The functionality associated with the engine 330, may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the system 100. The transceiver 320 may operate on a variety of different frequencies or channels (e.g., set of consecutive frequencies). Therefore, the transceiver 320 may include one or more components (e.g., radios) to enable the data exchange with the various networks and UEs.

As described above, the exemplary embodiments are related to various design configuration options for a single DCI to schedule multiple cells in the PDSCH and/or PUSCH. The following will provide examples of different types of configuration information the network may transmit to the UE 110 so that multiple cells may be scheduled using a single DCI. In the exemplary embodiments, the network may provide CCS configuration information to the UE 110. In the following examples, the CCS configuration information is provided by the network via one or more CrossCarrierSchedulingConfig IEs associated with the scheduling cell and the scheduled cells. This CCS configuration information may be used to configure the UE 110 with information to allow multiple cells to be scheduled using a single DCI.

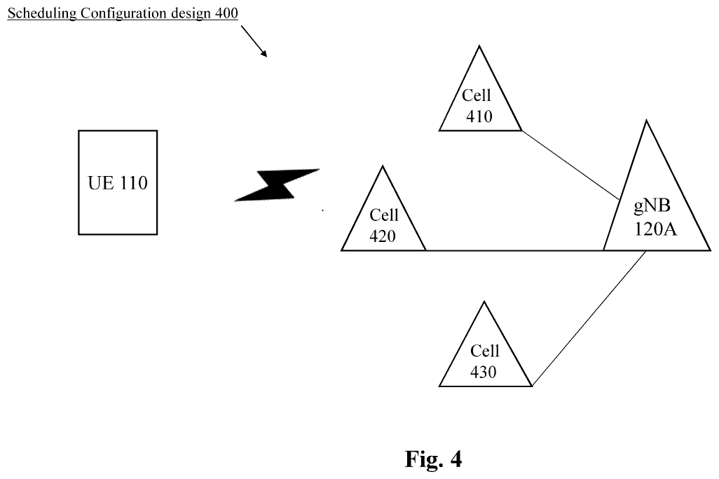

FIG. 4 shows an general overview of a multi-cell arrangement 400 where multiple cells may be scheduled for the UE 110 according to various exemplary embodiments. In this example, it may be considered that the gNB 120A includes cell A 410, cell B 420 and cell C 430. However, the cells used for the multi-cell scheduling are not required to be included in the same base station, e.g., one or more of the cells may be included as part of another base station that is not the gNB 120A. In addition, it should be understood that the number of cells (e.g., three) is only exemplary and more or less cells may be scheduled for the UE 110.

The exemplary embodiments are described with regard to a scenario in which the PDSCH and/or PUSCH for multiple cells (e.g., cell A 410, cell B 420 or cell C 430) may be scheduled for the UE 110 using a single DCI. In some embodiments, the CCS configuration information may be provided to the UE 110 in one or more radio resource control (RRC) messages. In other embodiments, the CCS configuration information may be provided to the UE 110 in one or more medium access control (MAC) control elements (CEs). However, the exemplary embodiments are not limited to RRC messages or MAC CEs, the CCS configuration information may be provided to the UE 110 in any appropriate manner.

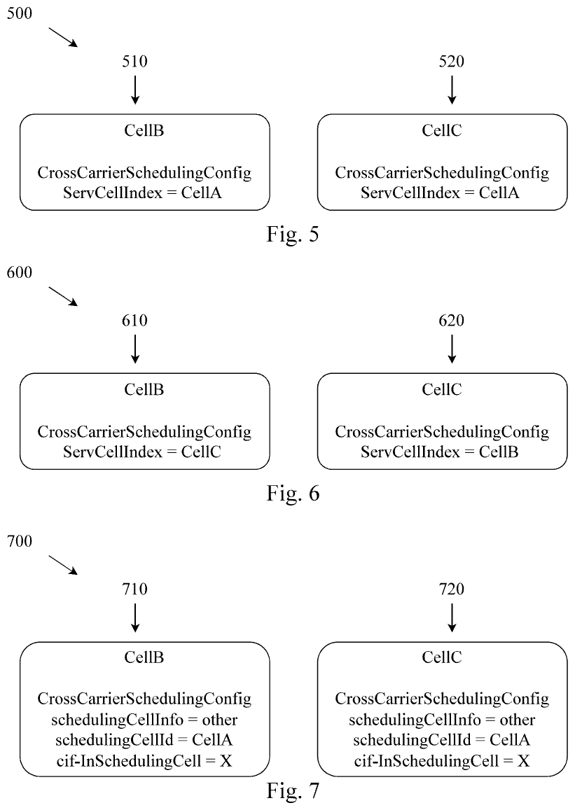

FIG. 5 shows a first example multi-cell scheduling configuration 500 according to various exemplary embodiments. In the example of FIG. 5, it may be considered that a single DCI may be allowed to schedule multi-cell PUSCH/PDSCH, e.g., the cell A 410 may schedule cell B 420 and cell C 430 using a single DCI. Thus, in this example, the cell A 410 may be considered to be the scheduling cell and cell B 420 and cell C 430 may be considered to be the scheduled cell(s). To accomplish this exemplary CCS scheduling, the UE 110 must understand that the scheduled cells may be scheduled by the scheduling cells. This is accomplished by the network providing the UE 110 with CCS configuration information, e.g., the CrossCarrierSchedulingConfig IEs 510 and 520 for the cell B 420 and cell C 430, respectively. The CCS configuration information provided in the CrossCarrierSchedulingConfig IEs 510 and 520 is described in greater detail below.

The CrossCarrierSchedulingConfig IE 510 of the first scheduled cell B 420 is configured to be scheduled by the scheduling cell A 410 by including the ServCellIndex of scheduling cell A 410 in the CrossCarrierSchedulingConfig IE 510 of cell B 420. Similarly, the CrossCarrierSchedulingConfig IE 520 of the second scheduled cell C 430 is configured to be scheduled by the scheduling cell A 410 by including the ServCellIndex of scheduling cell A 410 in the CrossCarrierSchedulingConfig IE 520 of cell C 430.

Thus, based on this configuration, the UE 110 understands cell A 410 is a scheduling cell configured to schedule cell B 420 and cell C 430 using a single DCI.

FIG. 6 shows a second example multi-cell scheduling configuration 600 according to various exemplary embodiments. In the example of FIG. 6, it may again be considered that a single DCI may be allowed to schedule multi-cell PUSCH/PDSCH, e.g., the cell A 410 may schedule cell B 420 and cell C 430 using a single DCI. This is again accomplished by the network providing the UE 110 with CCS configuration information, e.g., the CrossCarrierSchedulingConfig IEs 610 and 620 for the cell B 420 and cell C 430, respectively. The CCS configuration information provided in the CrossCarrierSchedulingConfig IEs 610 and 620 is described in greater detail below but is different from the information described above with respect to FIG. 5.

The CrossCarrierSchedulingConfig IE 610 of the first scheduled cell B 420 is configured with the ServCellIndex of second scheduled cell C 430. Similarly, the CrossCarrierSchedulingConfig IE 620 of the second scheduled cell C 430 is configured with the ServCellIndex of the first scheduled cell B 420. Thus, based on this configuration, the UE 110 understands that cell B 420 and cell C 430 may be scheduled using a single DCI. It should be understood that there may be additional information included in the corresponding CrossCarrierSchedulingConfig IEs 610 and 620 that indicates that cell A 410 is the scheduling cell.

FIG. 7 shows a third example multi-cell scheduling configuration 700 according to various exemplary embodiments. In the example of FIG. 7, it may again be considered that a single DCI may be allowed to schedule multi-cell PUSCH/PDSCH, e.g., the cell A 410 may schedule cell B 420 and cell C 430 using a single DCI. This is again accomplished by the network providing the UE 110 with CCS configuration information, e.g., the CrossCarrierSchedulingConfig IEs 710 and 720 for the cell B 420 and cell C 430, respectively. The CCS configuration information provided in the CrossCarrierSchedulingConfig IEs 710 and 720 is described in greater detail below but is different from the information described above with respect to FIGS. 5 and 6.

The CrossCarrierSchedulingConfig IE 710 for cell B 420 first indicates that cell B 420 is scheduled by another cell. Specifically, the schedulingCellinfo is set to “other,” meaning that the cell B 420 will not schedule itself. The schedulingCellId is set to the identification of the scheduling cell, in this case cell A 410. Thus, from this information, the UE 110 will understand that cell B 420 is scheduled by cell A 410. However, the CrossCarrierSchedulingConfig IE 710 also includes a cross carrier indicator field (CIF). This is represented in FIG. 7 as cif-InSchedulingCell=X. The CIF may be represented by X, with X being any value between 1 and 7. This value of the CIF may correspond to various information such as, but not limited to, a number of cells that may be simultaneously scheduled, preconfigured to correspond to scheduled cells, etc. In this example, when the UE 110 receives CIF-InSchedulingCell=X, the UE 110 would determine what value between 1 and 7 applies to X. Based on the value of the CIF, the UE 110 will understand what other cells may be simultaneously scheduled with cell B 420 using the same DCI. As will be described in more detail below, in this example, this will include cell C 430 because that cell will also have the same CIF configuration (e.g., CIF=X).

The CrossCarrierSchedulingConfig IE 720 for cell C 430 is similar to the CrossCarrierSchedulingConfig IE 710 of cell B 420. Specifically, the schedulingCellinfo is set to “other” indicating the cell C 430 is not self-scheduled, the schedulingCellId set to cell A 410 indicating that cell A 410 is the scheduling cell and the CIF-InSchedulingCell is set to “X.” Thus, based on the value of the CIF in the corresponding CrossCarrierSchedulingConfig IEs 710 and 720, the UE 110 will be configured by the network such that cell B 420 and cell C 430 may be scheduled simultaneously in the same DCI.

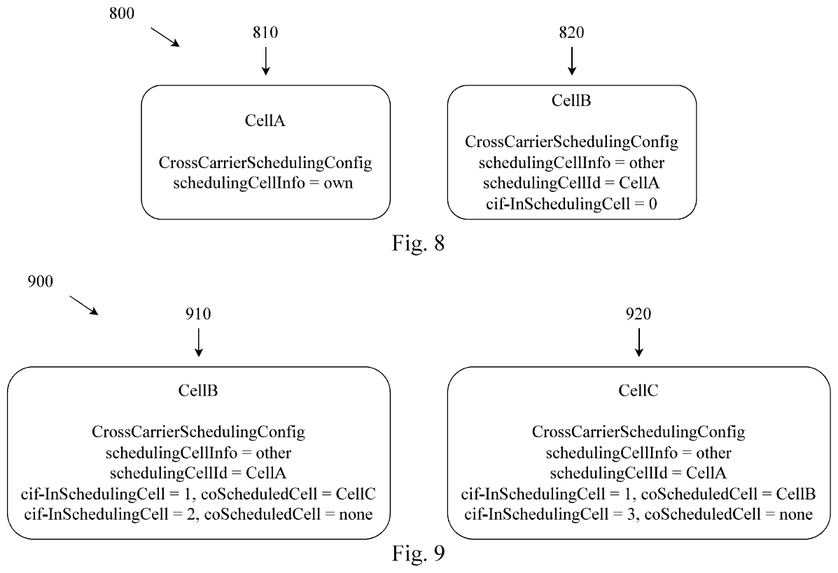

FIG. 8 shows a fourth example multi-cell scheduling configuration 800 according to various exemplary embodiments. In the example of FIG. 8, it may again be considered that a single DCI may be allowed to schedule multi-cell PUSCH/PDSCH. However, in this example, one of the scheduled cells is also the scheduling cell, e.g., the scheduling cell is self-scheduled. Thus, in this example, it may be considered that cell A 410 is both a scheduling cell and a scheduled cell and that cell A 410 may schedule cell A 410 and cell B 420 using a single DCI. This is again accomplished by the network providing the UE 110 with CCS configuration information, e.g., the CrossCarrierSchedulingConfig IEs 810 and 820 for cell A 410 and cell B 420, respectively. The CCS configuration information provided in the CrossCarrierSchedulingConfig IEs 810 and 820 is described in greater detail below.

The CrossCarrierSchedulingConfig IE 810 for cell A 410 is shown to include a schedulingCellinfo of “own”. This configuration indicates to the UE 110 that cell A 410 is configured to self-schedule as opposed to being scheduled by another scheduling cell. The CrossCarrierSchedulingConfig IE 820 for cell B 420 is similar to the configuration described above for CrossCarrierSchedulingConfig IE 710, e.g., the schedulingCellinfo is set to “other,” meaning that the cell B 420 will not schedule itself and the schedulingCellId is set to the identification of the scheduling cell, in this case cell A 410. Thus, from this information, the UE 110 will understand that cell B 420 is scheduled by cell A 410. However, unlike the above example, the CIF-InSchedulingCell is set to 0. A value of 0 for the CIF may indicate to the UE 110 that the scheduling cell (e.g., cell A 410) is a self-scheduling cell. Thus, the UE 110 will understand from this configuration that cell A 410 may schedule cell A 410 and cell B 420 in the same DCI.

FIG. 9 shows a fifth example multi-cell scheduling configuration 900 according to various exemplary embodiments. In the example of FIG. 9, it may again be considered that a single DCI may be allowed to schedule multi-cell PUSCH/PDSCH, e.g., the cell A 410 may schedule cell B 420 and cell C 430 using a single DCI. This is again accomplished by the network providing the UE 110 with CCS configuration information, e.g., the CrossCarrierSchedulingConfig IEs 910 and 920 for the cell B 420 and cell C 430, respectively. The CCS configuration information provided in the CrossCarrierSchedulingConfig IEs 910 and 920 is described in greater detail below.

As described above, in some exemplary embodiments, the value of the CIF may be preconfigured to correspond to different cell scheduling combinations. The example of FIG. 9 is related to this type of exemplary embodiment. In the example of FIG. 9, it may be considered that, for cell A 410, the CIF mapping may be represented as “CIF=1: CellB+CellC”, “CIF=2: CellB” “CIF =3: CellC”, etc. It should be understood that the cell referred to in the mapping is not required to exist.

The CrossCarrierSchedulingConfig IE 910 for cell B 420 is configured with the schedulingCellinfo set to “other,” meaning that the cell B 420 will not schedule itself and the schedulingCellId set to the identification of the scheduling cell, in this case cell A 410. In the exemplary embodiment, cell A 410 may be configured to schedule cell B 420 in two manners. In a first manner, cell B 420 may be scheduled by cell A 410 without a further configuration for another scheduled cell, e.g., CIF=2. In a second manner, cell B 420 may be scheduled by cell A 410 in the same DCI as another cell (cell C 430), e.g., CIF=1. Again, it should be understood that various schedule cell combinations may be represented by the preconfigured CIF values. In addition, the example that the CIF value is between 1 and 7 is also only exemplary and more or less CIF values may be preconfigured.

The CrossCarrierSchedulingConfig IE 920 for cell C 430 is also configured with the schedulingCellinfo set to “other,” meaning that the cell C 430 will not schedule itself and the schedulingCellId set to the identification of the scheduling cell, in this case cell A 410. In the exemplary embodiment, cell A 410 may be configured to schedule cell C 430 in two manners. In a first manner, cell C 430 may be scheduled by cell A 410 without a further configuration for another scheduled cell, e.g., CIF=3. In a second manner, cell C 420 may be scheduled by cell A 410 in the same DCI as another cell (cell B 420), e.g., CIF=1.

Thus, when the UE 110 receives this CCS configuration information, the UE 110 will understand the various cell configurations that may be simultaneously scheduled by a single DCI. In the example of FIG. 9, it should be understood that when the UE 110 receives the DCI from cell A 410, the DCI (or some other signal) will include the CIF value for the configured scheduling. The UE 110 may then use this information to receive the scheduling information in the DCI.

Those skilled in the art will understand that the DCI may include information for more than one UE and that the DCI may include more information than scheduling information. The UE 110 needs to search the DCI to find the specific scheduling information that is intended for the UE 110. However, searching the entire DCI is both a processor and power intensive operation. Thus, when multiple cells are allowed to be scheduled using a single DCI, it would be helpful to the UE 110 if the CCS configuration information included search space information for the UE 110 to efficiently search the DCI.

In the following examples, the CCS configuration information comprises search space configuration information to allow the UE 110 to efficiently search the DCI for scheduling information when multiple cells are allowed to be scheduled using a single DCI. In this configuration, the scheduling cell configures the search space of DCI configured to schedule multiple cells by determining the time and mode of scheduling the DCI (e.g., the frequency domain).

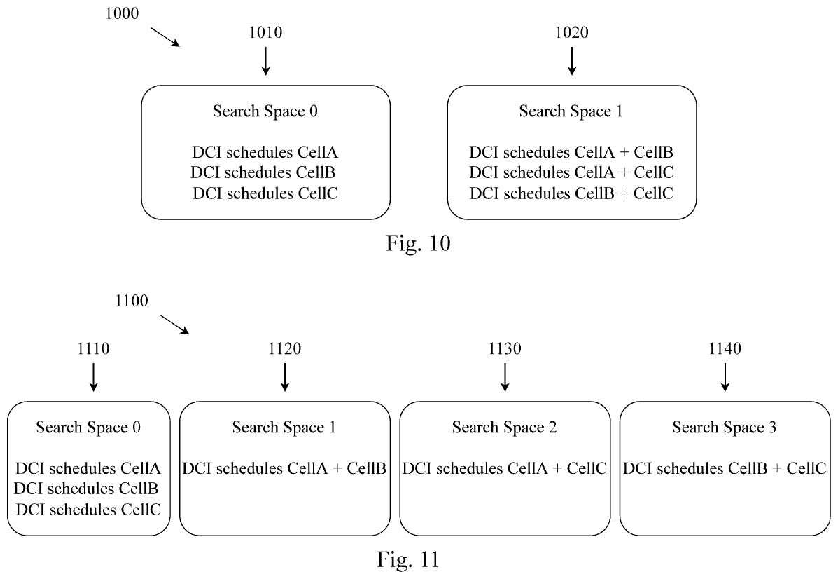

FIG. 10 shows a first example multi-cell search space scheduling configuration 1000 according to various exemplary embodiments. In the example of FIG. 10 it may be considered that the scheduling cell may schedule multiple cells or a single cell in a DCI search space. In this example it may be considered that cell A 410 is the scheduling cell and that cell A 410 may schedule any of the following: cell A 410 only; cell B 420 only; cell C 430 only; cell A 410 and cell B 420; cell A 410 and cell C 430; or cell B 420 and cell C 430. The CCS configuration information may include search space configuration information that may be used by the UE 110 to efficiently search the DCI.

In the example of FIG. 10, the search space configuration information comprises two search spaces, search space configuration (0) 1010 and search space configuration (1) 1020. In this example, search space configuration (0) 1010 is configured to include a search space having scheduling information for a single cell, e.g., cell A 410, cell B 420 or cell C 430. In contrast, search space configuration (1) 1020 is configured to include a search space having scheduling information for various cell combinations, e.g., cell A 410 and cell B 420; cell A 410 and cell C 430; or cell B 420 and cell C 430.

Thus, when the UE 110 receives the CCS configuration information including the search space configuration information and the configuration information regarding the cells that are to be scheduled by the DCI, e.g., the CCS configuration information described with respect to FIGS. 5-9, the UE 110 will understand which DCI search space to search for the individual UE 110 scheduling information.

To provide a specific example related to the search space configuration information shown in FIG. 10, it may be considered that the UE 110 is configured with CCS configuration information indicating that the scheduling cell can simultaneously schedule cell A 410 and cell B 420 and the DCI may be decoded to indicate the type of scheduling that may occur. Thus, based on the search space configuration information as shown in FIG. 10, the UE 110 will understand to search the search space as configured by the search space (1) 1020.

FIG. 11 shows a second example multi-cell search space scheduling configuration 1100 according to various exemplary embodiments. In the example of FIG. 11 it may again be considered that the scheduling cell may schedule multiple cells or a single cell in a DCI search space. In this example it may be considered that cell A 410 is the scheduling cell and that cell A 410 may schedule any of the following: cell A 410 only; cell B 420 only; cell C 430 only; cell A 410 and cell B 420; cell A 410 and cell C 430; or cell B 420 and cell C 430. However, it may also be considered that different cell combinations cannot be configured in the same search space, e.g., a cell cannot be scheduled in more than one combination. The CCS configuration information may include search space configuration information that may be used by the UE 110 to efficiently search the DCI under this scenario.

In the example of FIG. 11, the search space configuration information comprises four search spaces, search space configuration (0) 1110,: search space configuration (1) 1120, search space configuration (2) 1130 and search space configuration (3) 1140. In this example, search space configuration (0) 1110 is configured to include a search space having scheduling information for a single cell, e.g., cell A 410, cell B 420 or cell C 430. In contrast, search space configuration (1) 1120 is configured to include a search space having scheduling information for cell combination cell A 410 and cell B 420. The search space configuration (2) 1130 is configured to include a search space having scheduling information for cell combination cell A 410 and cell C 430. The search space configuration (3) 1140 is configured to include a search space having scheduling information for cell combination cell B 420 and cell C 430.

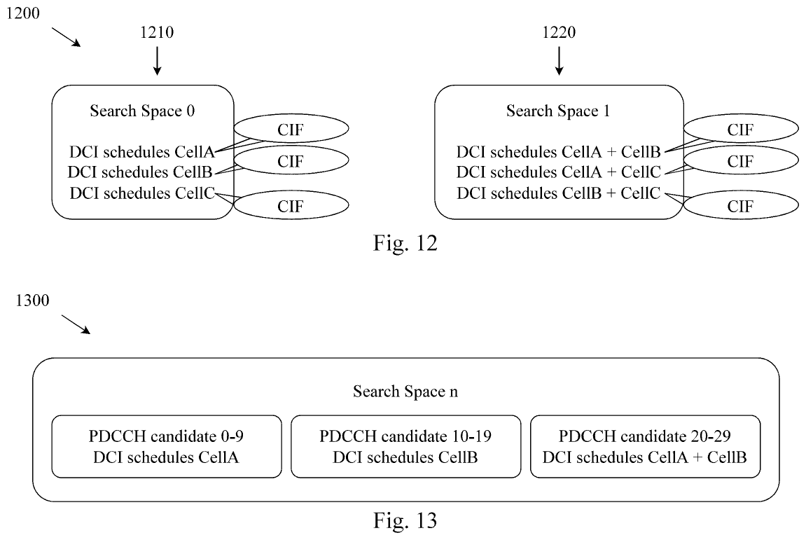

FIG. 12 shows a third example multi-cell search space scheduling configuration 1200 according to various exemplary embodiments. In the example of FIG. 12 it may again be considered that the scheduling cell may schedule multiple cells or a single cell in a DCI search space. In this example it may be considered that cell A 410 is the scheduling cell and that cell A 410 may schedule any of the following: cell A 410 only; cell B 420 only; cell C 430 only; cell A 410 and cell B 420; cell A 410 and cell C 430; or cell B 420 and cell C 430. In the exemplary configuration of FIG. 12, the search space configuration information also includes a CIF associated with the scheduled cell to inform the UE 110 of the type of scheduling that may occur. The CCS configuration information may include search space configuration information that may be used by the UE 110 to efficiently search the DCI.

In the example of FIG. 12, the search space configuration information comprises two search spaces, search space configuration (0) 1210 and search space configuration (1) 1220. In this example, search space configuration (0) 1210 is configured to include a search space having scheduling information for a single cell, e.g., cell A 410, cell B 420 or cell C 430. However, there is also a CIF value associated with each scheduled cell. The search space configuration (1) 1220 is configured to include a search space having scheduling information for various cell combinations, e.g., cell A 410 and cell B 420; cell A 410 and cell C 430; or cell B 420 and cell C 430. Again, each of these cell combinations also have an associated CIF value.

Thus, when the UE 110 receives a CIF value in the DCI, the UE 110 will understand which search space to search based on the search space configuration information. In some exemplary embodiments, if single cell scheduling or multi-cell scheduling is semi-statically configured in different search spaces (e.g., search space (0), search space (1), etc.), the same CIF may be interpreted differently to reflect the search space configuration.

It should also be understood that the example of FIG. 12 is shown with the search spaces set up in a similar configuration as the search spaces of FIG. 10. In other embodiments, the CIF value(s) may also be included in the search space configuration information when the search spaces are configured in a manner similar to the example of FIG. 11.

FIG. 13 shows a fourth example multi-cell search space scheduling configuration 1300 according to various exemplary embodiments. In this exemplary configuration 1300, the search space may be configured to include a one-to-one mapping of a PDCCH candidate and a scheduled cell. The PDCCH candidates are decoded to schedule the appropriate cells. Thus, the scheduling cell implements a scheduling decision of one-to-one mapping for the PDCCH candidate, and the cells configured to be scheduled by the scheduling cell via the DCI. For example, a first PDCCH candidate may be decoded to schedule cell A and therefore is mapped to cell A in the search space, a second PDCCH candidate may be decoded to schedule cell B and therefore mapped to cell B in the search space, etc. Thus, when the UE 110 does not support search space sharing, and the gNB 120A wants to schedule a combination of cells (e.g., cell A 410 and cell B 420), the gNB 120A may utilize a PDCCH candidate that is not mapped to one of the individual cells as shown in the FIG. 13 PDCCH candidates for scheduling of the combination of cell A 410 and cell B 420.

Prior to decoding the PDCCH candidate, the cells configured to be scheduled by the DCI are defined. Once the cells are defined, the PDCCH candidate may be decoded to schedule each cell in the search space accordingly. As shown in in FIG. 13, the scheduling configuration 1300 includes a search space n with PDCCH candidates mapped to the DCI scheduled cells. For example, PDCCH candidate 0-9 can only schedule cell A and PDCCH candidate 10-19 can only schedule cell B. The search space 0 further includes a PDCCH candidate 20-29 mapped to a scheduling combination of “cell A+cell B”. Advantageously, this configuration allows the UE 110 to minimize any potential processing complexity increase since the DCI is allowed to schedule multiple cells within the search space.

When a single DCI is allowed to schedule Multi-cell PUSCH/PDSCH, the detailed search space configuration information may be configured in multiple manners. In some exemplary embodiments, the search space configuration information may be configured in the scheduling cell. For example, the various IEs related to the search space configuration such as slot offset, periodicity, duration etc., may be configured in the scheduling cell. In other exemplary embodiments, the number of PDCCH candidates may be configured in the scheduled cell while the other IEs of the search space configuration are configured in the scheduling cell to generate a link between the search space in the scheduled cell and the search space in the scheduling cell. The search spaces may be linked with the same SearchSpaceId.

In further exemplary embodiments, the configuration for a number of unicast DCI the UE 110 is expected to decode may be implemented for multi-cell PUSCH or PDSCH scheduling in the single DCI. Under conventional circumstances, the UE 110 is expected to detect a certain number of unicast DCI for every PDCCH monitoring occasion. However, the gNB 120A may be restricted with regards to scheduling a significant number of unicast DCI for the given slot beyond the detection capacity of the UE 110. Thus, the gNB 120A may adopt different PDCCH monitoring capability per slot/span per scheduled component carrier (CC). For example, the gNB 120A may adopt a basic PDCCH monitoring capability FG3-1, per slot per scheduled CC. In this example, the gNB 120A can only schedule maximum one unicast downlink (DL) DCI and one unicast uplink (UL) DCI for a frequency division duplex (FDD) cell, and one unicast DL DCI and two unicast UL DCI for a time division duplex (TDD) cell. In another example, the gNB 120A may adopt an advanced span based PDCCH monitoring capability FG3-5, per span per scheduled CC. In the advanced monitoring, the gNB 120A can only schedule maximum one unicast DL DCI and one unicast UL DCI for a FDD cell and either, one unicast DL DCI and two unicast UL DCI, or two unicast DL DCI and one unicast UL DCI for a TDD cell. In a further example, the gNB 120A may adopt an enhanced advanced span based PDCCH monitoring capability FG11-2, per span per scheduled CC. In the enhanced advanced monitoring, the gNB 120A can only schedule maximum one unicast DL DCI and one unicast UL DCI for a FDD cell and either, one unicast DL DCI and two unicast UL DCI, or two unicast DL DCI and one unicast UL DCI for a TDD cell. However, the above examples can be enhanced when the DCI is configured to schedule multiple cells in PDSCH as will be described in various embodiments below.

In one exemplary embodiment, when the DCI is configured to schedule multi-cell PDSCH, the number of unicast DCI the UE 110 expects to decode may be significantly reduced. For example, in case the UE 110 is required to decode two unicast in DL DCI, the unicast DL DCI may be reduced to one. This may be achieved when a single DCI is configured to schedule multiple cells rather than a single DCI configured to schedule PDCSH on one cell. Based on the DCI multi-cell PDSCH scheduling configuration, the number of unicast DCI the UE 110 is expected to decode may be reduced. Consequently, the number of unicast DCI may be reduced when a single DCI is scheduling multiple cells in PDSCH because the UE 110 encounters less unicast to decode. Alternatively, when two unicast DCI have to be decoded, the network may introduce a relaxation to the UE 110 to decode only one unicast DCI because the DCI may be configured to schedule more than one cell. For example, in case the UE 110 is configured to decode one unicast DL DCI, the decoding may be reduced to X>1 slots or span per scheduled cell, where X may be a fixed or sliding window.

In another exemplary embodiment, when the DCI is configured to schedule multi-cell PUSCH, the number of unicast DCI the UE 110 expects to decode may be significantly reduced. For example, in case the UE 110 is required to decode two unicast in UL DCI, the unicast UL DCI may be reduced to one. This may be achieved when a single DCI is configured to schedule multiple cells rather than a single DCI configured to schedule PDCSH on one cell. Based on the DCI multi-cell PUSCH scheduling configuration, the number of unicast DCI the UE 110 is expected to decode may be reduced. Consequently, the number of unicast DCI may be reduced when a single DCI is scheduling multiple cells in PUSCH because the UE 110 encounters less unicast to decode. Alternatively, when two unicast DCI have to be decoded, the network may introduce a relaxation to the UE 110 to decode only one unicast DCI because the DCI may be configured to schedule more than one cell. For example, in case the UE 110 is configured to decode one unicast UL DCI, the decoding may be reduced to X>1 slots or span per scheduled cell, where X may be a fixed or sliding window.

In further exemplary embodiment, if the UE 110 decodes a single DCI configured to schedule multiple cells, the single DCI is counted as the number of scheduled cells in the number unicast DCI counting. For example, if two cells are scheduled in the single DCI, then two cells are counted for the unicast DCI. That is, one unicast DCI is counted more depending on the number of cells.

In a further exemplary embodiment, a configuration restriction may be implemented for multi-cell PUSCH or PDSCH scheduling in the single DCI. The configuration restriction allows the single DCI schedule multiple cells in PUSCH or PDSCH efficiently.

In one aspect, a non-fallback DCI may be used to schedule multi-cell PUSCH or PDSCH. This restriction provides the UE 110 with scheduling flexibility for scheduling multiple cells via the single DCI. For example, for DCI format 0_1, 0_2 may be used to schedule multi-cell PDSCH. In another example, example, for DCI format 1_1, 1_2 may be used to schedule multi-cell PDSCH.

In another aspect, all the scheduled cells configured to be scheduled by the same DCI simultaneously are combined into groups to satisfy the configuration restriction. For example, the scheduled cells may be placed in the same PUCCH group or the same cell group. This allows the UE 110 to perform dynamic operations on different groups efficiently.

### EXAMPLES

In a first example, a user equipment (UE) comprises a transceiver configured to communicate with a network and a processor communicatively coupled to the transceiver and configured to receive, from the network, scheduling configuration information related to scheduling a physical downlink shared channel (PDSCH) or a physical uplink shared channel (PUSCH) for the UE, receive, from a scheduling cell of the network, downlink control information (DCI) comprising scheduling information for the PDSCH or PUSCH for a plurality of scheduled cells, decode the DCI and determine a schedule for each of the scheduled cells based on at least the scheduling configuration information and the scheduling information.

In a second example, the UE of the first example, wherein the scheduling configuration information comprises cross carrier scheduling (CCS) configuration information for each of the scheduled cells.

In a third example, the UE of the second example, wherein the CCS configuration information for each of the scheduled cells comprises an identification of the scheduling cell.

In a fourth example, the UE of the second example, wherein the CCS configuration information for each of the scheduled cells comprises an identification of other scheduled cells that can be scheduled with the scheduled cell.

In a fifth example, the UE of the second example, wherein the CCS configuration information for each of the scheduled cells comprises an identification of the scheduling cell and a carrier indicator field (CIF) corresponding to a multi-cell scheduling configuration that identifies at least two of the plurality of scheduled cells that can be scheduled by the DCI.

In a sixth example, the UE of the second example, wherein the CCS configuration information comprises an indication of whether the scheduling cell is self-scheduled.

In a seventh example, the UE of the sixth example, wherein, when the scheduling cell is self-scheduled, the CCS configuration information for the scheduled cells that are not the scheduling cell comprises an identification of the scheduling cell and a carrier indicator field (CIF) indicating the scheduling cell is one of the scheduled cells.

In an eighth example, the UE of the second example, wherein the CCS configuration information for each scheduled cell comprises a list of carrier indicator field (CIF) values, wherein each CIF value identifies one of zero, only one or at least one of the plurality of scheduled cells that can be scheduled with the scheduled cell.

In a ninth example, the UE of the first example, wherein the scheduling configuration information comprises search space configuration information for the DCI.

In a tenth example, the UE of the ninth example, wherein the search space configuration information comprises a configuration of a first search space that includes scheduling information for individual scheduled cells and a second search space for combinations of scheduled cells.

In an eleventh example, the UE of the tenth example, wherein the first search space configuration further comprises a carrier indicator field (CIF) value for each individual scheduled cell and the second search space configuration further comprises a CIF value for each of the combinations of scheduled cells.

In a twelfth example, the UE of the eleventh example, wherein one of the CIF values configured for the first search space and one of the CIF values configured for the second search space comprise a same value with a different search space configuration.

In a thirteenth example, the UE of the ninth example, wherein the search space configuration information comprises a configuration of a first search space that includes scheduling information for individual scheduled cells, a second search space for a first combination of scheduled cells and a third search space for a second combination of scheduled cells, wherein the first combination is different from the second combination.

In a fourteenth example, the UE of the thirteenth example, wherein the first search space configuration further comprises a carrier indicator field (CIF) value for each individual scheduled cell, the second search space configuration further comprises a CIF value for the first combination of scheduled cells and the third search space configuration further comprises a CIF value for the second combination of scheduled cells.

In a fifteenth example, the UE of the ninth example, wherein the search space configuration information comprises a list of PDCCH candidates corresponding to each individual scheduled cell and each combination of scheduled cells.

In a sixteenth example, the UE of the fifteenth example, wherein the search space configuration information comprises a number of PDCCH candidates, a slot offset, a periodicity, and a duration.

In a seventeenth example, the UE of the sixteenth example, wherein the search space configuration is only included in the scheduling configuration information for the scheduling cell.

In an eighteenth example, the UE of the sixteenth example, wherein the number of PDCCH candidates is included in the scheduling configuration information for each scheduled cell and the slot offset, periodicity, and duration is included in the scheduling configuration information for the scheduling cell.

In a nineteenth example, the UE of the eighteenth example, wherein the scheduling configuration information of the scheduling cell and the scheduled cells are linked based on an identification of a search space.

In a twentieth example, the UE of the first example, wherein, when the DCI comprises PDSCH scheduling information and the UE expects to decode two unicast downlink (DL) DCI, the processor is further configured to decode only one unicast DL DCI per scheduled cell.

In a twenty first example, the UE of the first example, wherein, wherein, when the DCI comprises PDSCH scheduling information and the UE expects to decode one unicast downlink (DL) DCI, the processor is further configured to decode one unicast DL DCI per scheduled cell within a window comprising a number of slots, wherein the window has either a fixed location or a sliding location.

In a twenty second example, the UE of the first example, wherein, when the DCI comprises PUSCH scheduling information and the UE expects to decode two unicast uplink (UL) DCI, the processor is further configured to decode only one unicast UL DCI per scheduled cell.

In a twenty third example, the UE of the first example, wherein, when the DCI comprises PUSCH scheduling information and the UE expects to decode one unicast uplink (UL) DCI, the processor is further configured to decode one unicast UL DCI per scheduled cell within a window comprising a number of slots, wherein the window has either a fixed location or a sliding location.

In a twenty fourth example, the UE of the first example, wherein, when the decoded DCI is a unicast DCI and comprises scheduling information for multiple scheduled cells, the processor is further configured to count the decoded unicast DCI as the number of scheduled cells in a number of unicast DCI counting.

In a twenty fifth example, the UE of the first example, wherein the DCI comprises a non-fallback DCI.

In a twenty sixth example, the UE of the twenty fifth example, wherein the non-fallback DCI for the PUSCH comprises a DCI Format 0_1 or a DCI Format 0_2.

In a twenty seventh example, the UE of the twenty fifth example, wherein the non-fallback DCI for the PDSCH comprises a DCI Format 1_1 or a DCI Format 1_2.

In a twenty eighth example, the UE of the first example, wherein the plurality of scheduled cells are in a same Physical Uplink Control Channel (PUCCH) group.

In a twenty ninth example, the UE of the first example, wherein the plurality of scheduled cells are in a same cell group.

In a thirtieth example, a processor of a base station is configured to send, to a user equipment (UE), scheduling configuration information related to scheduling a physical downlink shared channel (PDSCH) or a physical uplink shared channel (PUSCH) for the UE and send, to the UE, downlink control information (DCI) comprising scheduling information for the PDSCH or PUSCH for a plurality of scheduled cells.

In a thirty first example, the processor of the thirtieth example, wherein the scheduling configuration information comprises cross carrier scheduling (CCS) configuration information for each of the scheduled cells.

In a thirty second example, the processor of the thirty first example, wherein the CCS configuration information for each of the scheduled cells comprises an identification of the scheduling cell.

In a thirty third example, the processor of the thirty first example, wherein the CCS configuration information for each of the scheduled cells comprises an identification of other scheduled cells that can be scheduled with the scheduled cell.

In a thirty fourth example, the processor of the thirty first example, wherein the CCS configuration information for each of the scheduled cells comprises an identification of the scheduling cell and a carrier indicator field (CIF) corresponding to a multi-cell scheduling configuration that identifies at least two of the plurality of scheduled cells that can be scheduled by the DCI.

In a thirty fifth example, the processor of the thirty first example, wherein the CCS configuration information comprises an indication of whether the scheduling cell is self-scheduled.

In a thirty sixth example, the processor of the thirty fifth example, wherein, when the scheduling cell is self-scheduled, the CCS configuration information for the scheduled cells that are not the scheduling cell comprises an identification of the scheduling cell and a carrier indicator field (CIF) indicating the scheduling cell is one of the scheduled cells.

In a thirty seventh example, the processor of the thirty first example, wherein the CCS configuration information for each scheduled cell comprises a list of carrier indicator field (CIF) values, wherein each CIF value identifies one of zero, only one or at least one of the plurality of scheduled cells that can be scheduled with the scheduled cell.

In a thirty eighth example, the processor of the thirtieth example, wherein the scheduling configuration information comprises search space configuration information for the DCI.

In a thirty ninth example, the processor of the thirty eighth example, wherein the search space configuration information comprises a configuration of a first search space that includes scheduling information for individual scheduled cells and a second search space for combinations of scheduled cells.

In a fortieth example, the processor of the thirty ninth example, wherein the first search space configuration further comprises a carrier indicator field (CIF) value for each individual scheduled cell and the second search space configuration further comprises a CIF value for each of the combinations of scheduled cells.

In a forty first example, the processor of the fortieth example, wherein one of the CIF values configured for the first search space and one of the CIF values configured for the second search space comprise a same value with a different search space configuration.

In a forty second example, the processor of the thirty eighth example, wherein the search space configuration information comprises a configuration of a first search space that includes scheduling information for individual scheduled cells, a second search space for a first combination of scheduled cells and a third search space for a second combination of scheduled cells, wherein the first combination is different from the second combination.

In a forty third example, the processor of the forty second example, wherein the first search space configuration further comprises a carrier indicator field (CIF) value for each individual scheduled cell, the second search space configuration further comprises a CIF value for the first combination of scheduled cells and the third search space configuration further comprises a CIF value for the second combination of scheduled cells.

In a forty fourth example, the processor of the thirty eighth example, wherein the search space configuration information comprises a list of PDCCH candidates corresponding to each individual scheduled cell and each combination of scheduled cells.

In a forty fifth example, the processor of the forty fourth example, wherein the search space configuration information comprises a number of PDCCH candidates, a slot offset, a periodicity, and a duration.

In a forty sixth example, the processor of the forty fifth example, wherein the search space configuration is only included in the scheduling configuration information for the scheduling cell.

In a forty seventh example, the processor of the forty fifth example, wherein the number of PDCCH candidates is included in the scheduling configuration information for each scheduled cell and the slot offset, periodicity, and duration is included in the scheduling configuration information for the scheduling cell.

In a forty eighth example, the processor of the forty seventh example, wherein the scheduling configuration information of the scheduling cell and the scheduled cells are linked based on an identification of a search space.

In a forty ninth example, the processor of the thirtieth example, wherein the DCI comprises a non-fallback DCI.

In a fiftieth example, the processor of the forty ninth example, wherein the non-fallback DCI for the PUSCH comprises a DCI Format 0_1 or a DCI Format 0_2.

In a fifty first example, the processor of the forty ninth example, wherein the non-fallback DCI for the PDSCH comprises a DCI Format 1_1 or a DCI Format 1_2.

In a fifty second example, the processor of the thirtieth example, wherein the plurality of scheduled cells are in a same Physical Uplink Control Channel (PUCCH) group.

In a fifty third example, the processor of the thirtieth example, wherein the plurality of scheduled cells are in a same cell group.

In a fifty fourth example a base station comprises a transceiver configured to communicate with a user equipment (UE) and a processor communicatively coupled to the transceiver and configured to perform any of the operations described above with respect to the thirtieth to the fifty third examples.

Those skilled in the art will understand that the above-described exemplary embodiments may be implemented in any suitable software or hardware configuration or combination thereof. An exemplary hardware platform for implementing the exemplary embodiments may include, for example, an Intel ×86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of a user equipment (UE) configured to:
receive, from a network, scheduling configuration information related to scheduling a physical downlink shared channel (PDSCH) or a physical uplink shared channel (PUSCH) for the UE;
receive, from a scheduling cell of the network, downlink control information (DCI) comprising scheduling information for the PDSCH or PUSCH for a plurality of scheduled cells;
decode the DCI; and
determine a schedule for each of the scheduled cells based on at least the scheduling configuration information and the scheduling information.

2. The processor of claim 1, wherein the scheduling configuration information comprises cross carrier scheduling (CCS) configuration information for each of the scheduled cells.

3. The processor of claim 2, wherein the CCS configuration information for each of the scheduled cells comprises an identification of the scheduling cell.

4. The processor of claim 2, wherein the CCS configuration information for each of the scheduled cells comprises an identification of other scheduled cells that can be scheduled with the scheduled cell.

5. The processor of claim 2, wherein the CCS configuration information for each of the scheduled cells comprises an identification of the scheduling cell and a carrier indicator field (CIF) corresponding to a multi-cell scheduling configuration that identifies at least two of the plurality of scheduled cells that can be scheduled by the DCI.

6. The processor of claim 2, wherein the CCS configuration information comprises an indication of whether the scheduling cell is self-scheduled.

7. The processor of claim 6, wherein, when the scheduling cell is self-scheduled, the CCS configuration information for the scheduled cells that are not the scheduling cell comprises an identification of the scheduling cell and a carrier indicator field (CIF) indicating the scheduling cell is one of the scheduled cells.

8. The processor of claim 2, wherein the CCS configuration information for each scheduled cell comprises a list of carrier indicator field (CIF) values, wherein each CIF value identifies one of zero, only one or at least one of the plurality of scheduled cells that can be scheduled with the scheduled cell.

9. The processor of claim 1, wherein the scheduling configuration information comprises search space configuration information for the DCI.

10. The processor of claim 9, wherein the search space configuration information comprises a configuration of a first search space that includes scheduling information for individual scheduled cells and a second search space for combinations of scheduled cells.

11. The processor of claim 10, wherein the first search space configuration further comprises a carrier indicator field (CIF) value for each individual scheduled cell and the second search space configuration further comprises a CIF value for each of the combinations of scheduled cells.

12. The processor of claim 11, wherein one of the CIF values configured for the first search space and one of the CIF values configured for the second search space comprise a same value with a different search space configuration.

13. The processor of claim 9, wherein the search space configuration information comprises a configuration of a first search space that includes scheduling information for individual scheduled cells, a second search space for a first combination of scheduled cells and a third search space for a second combination of scheduled cells, wherein the first combination is different from the second combination.

14. The processor of claim 13, wherein the first search space configuration further comprises a carrier indicator field (CIF) value for each individual scheduled cell, the second search space configuration further comprises a CIF value for the first combination of scheduled cells and the third search space configuration further comprises a CIF value for the second combination of scheduled cells.

15. The processor of claim 9, wherein the search space configuration information comprises a list of PDCCH candidates corresponding to each individual scheduled cell and each combination of scheduled cells.

16. The processor of claim 15, wherein the search space configuration information comprises a number of PDCCH candidates, a slot offset, a periodicity, and a duration.

17. The processor of claim 16, wherein the search space configuration is only included in the scheduling configuration information for the scheduling cell.

18. The processor of claim 16, wherein the number of PDCCH candidates is included in the scheduling configuration information for each scheduled cell and the slot offset, periodicity, and duration is included in the scheduling configuration information for the scheduling cell.

19. The processor of claim 18, wherein the scheduling configuration information of the scheduling cell and the scheduled cells are linked based on an identification of a search space.

20. The processor of claim 1, wherein, when the DCI comprises PDSCH scheduling information and the UE expects to decode two unicast downlink (DL) DCI, the processor is further configured to:
decode only one unicast DL DCI per scheduled cell.

21-29. (canceled)
